(19) United States
(12) Patent Application Publication
(10) Pub. No.: US 2023/0164189 A1
(43) Pub. Date: May 25, 2023

(54) RELATIONSHIP-BASED ACCESS CONTROL FOR IOT NETWORKS

(71) Applicant: Schneider Electric USA, Inc., Andover, MA (US)

(72) Inventors: Victor Danilchenko, South Hadley, MA (US); John Brodeur, Londonderry, NH (US)

(73) Assignee: Schneider Electric USA, Inc., Boston, MA (US)

(21) Appl. No.: 17/918,070

(22) PCT Filed: Jul. 5, 2021
(86) PCT No.: PCT/US2021/040402

§ 371 Date: Oct. 10, 2022

Related U.S. Application Data
(60) Provisional application No. 63/048,361, filed on Jul. 6, 2020.

(51) Int. Cl. H04L 9/40

(52) U.S. Cl. CPC H04L 63/20; H04L 63/102; H04L 63/0263

(57) ABSTRACT

Techniques are described for managing data access within a first computing environment. Embodiments include receiving a request, from a first requesting entity, to access a first resource. A query is generated and submitted to a graph-based database to determine one or more relationships between the first requesting entity and other entities covered by a security policy. The graph-based database models identities, resources and security relationships covered by the security policy. Embodiments determine, based n the determined one or more relationships and the security policy, whether the first entity is allowed to access the first resource according to the security policy.

### TECHNICAL FIELD

The present disclosure relates to electronic device security, and more particularly, to techniques for providing relationship-based access control for Internet of Things (IOT) networks using a graph database.

### BACKGROUND

IoT networks deliver great value with highly available data and computing resources. However, such networks also bring significant security and privacy challenges. Conventionally, these challenges have been addressed via the concept of “tenancy” as the framework for data isolation, yet the traditional concept of tenancy possess significant limitations. Device and data security are increasingly important considerations for modern IoT networks.

### BRIEF DESCRIPTION OF THE DRAWINGS

A more detailed description of the disclosure, briefly summarized above, may be had by reference to various embodiments, some of which are illustrated in the appended drawings. While the appended drawings illustrate select embodiments of this disclosure, these drawings are not to be considered limiting of its scope, for the disclosure may admit to other equally effective embodiments.

Identical reference numerals have been used, where possible, to designate identical elements that are common to the figures. However, elements disclosed in one embodiment may be beneficially utilized on other embodiments without specific recitation.

FIG. 1 illustrates a system configured with an access management component, according to one embodiment described herein.

FIG. 2 is a block diagram illustrating a system configured with an access management component and a data flow within the system, according to one embodiment described herein.

FIG. 3 is a flow diagram, illustrating a method of managing data access within a first computing environment, according to one embodiment described herein.

FIG. 4 is a diagram illustrating an organization of a graph database that models identities, resources and security relationships, according to one embodiment described herein.

FIG. 5 is a block diagram illustrating elements of a RelBAC system, according to one embodiment described herein.

### DETAILED DESCRIPTION

Internet of Things (IoT) networks deliver great value with seemingly omnipresent data and compute resources, yet also can pose significant challenges to security and privacy. Generally speaking, IoT systems bring pervasive computing to everyday life. Anything from a smart thermostat or a fridge to a smart assembly line or refinery safety equipment can be connected to the Internet, delivering tremendous value in the form of both data and control capabilities. IoT data is becoming increasingly valuable, and generally the value of this data is unlocked largely through analytics. The analytics value cascade generally includes descriptive analytics that, e.g., describe what is happening, diagnostic analytics that, e.g., give details on malfunctions, predictive analytics that, e.g., can suggest maintenance before a malfunction occurs, prescriptive analytics that, e.g., can suggest changes to avoid before a malfunction occurs, and productive analytics that can, e.g., suggest how to improve a product and production.

However, the “value” of data is not a singular quantity, and generally the true value of data depends on the context. For example, for a given embodiment, the value of collected data can depend on the production of the data, the usage of the data, the need or demand for the data, the available supply of data, and so on. In many environments today, the value of the data exists but has yet to be unlocked. While much of the value of data can be unlocked within an offer or product context, a vast potential value also exists in relating various heterogeneous bodies of data to each other—across offers, across domains, across administrative boundaries, etc.

Currently the management and processing of IoT data are typically done using the concept of “tenancy” as a way of isolating data in different administrative domains from each other. In other words, tenancy serves as a framework for data isolation. Data isolation is frequently of critical importance, as it relates to several cross-cutting concerns such as security, privacy, and regulatory compliance.

In many instances, it is desirable to selectively share data between various tenants within the IoT environment. However, such sharing must be closely managed to ensure data privacy and security are maintained and may present additional security challenges as well. Traditionally, these security challenges (including intra-tenant access requests and inter-tenant access requests) are addressed via various access control schemes. For example, a Role-Based Access Control (RBAC) system associates users within the network with various roles. The RBAC system can further specify a set of permissions for each respective role, and users assigned to these roles can inherit these permissions. Moreover, each resource within the network can be associated with a set of permissions. In this context, a resource could correspond to an IoT device, data collected from an IoT device, an aggregated data store, an analytics application, data produced by such an analytics application, and so on. For each resource access request, the RBAC system could determine whether the requesting user's permissions (as determined by one or more roles assigned to the requesting user) match the set of permissions associated with the requested resource. If the permissions match, the access request could be granted and if the user's permissions are insufficient (i.e., the user does not have the required permissions to access the resource), the resource access request could be denied.

Attribute-Based Access Control (ABAC) is another form of access control system used to secure resources in an IoT environment. In an ABAC system, each user is associated with a respective access policy that describes attributes of the user. Such attributes could include, for example, a username, a job title, one or more user responsibilities, and so on. Each resource within the IoT environment is also associated with attributes that describe the conditions that must be met before access to the respective resource is granted. When a resource access request is received, the ABAC system attempts to match the attributes required to access the resource with the attributes of the requesting entity, and grants access if the required attributes are satisfied.

While such access control systems solve many problems and provide numerous advantages, these access control systems have limitations and disadvantages as well. For example, in a particular IoT environment, a given data source may be owned or managed by a first organization, but the data could be used or consumed by a different organization(s). In such an environment, the data consumers may want to access the data at various stages of the process, e.g., the raw data stream, at an intermediate transformation point, at a normalized or optimized point in the process, or as an anonymized data set. To achieve this in an RBAC or ABAC system, however, custom roles and attributes must be manually defined to allow each desired access. Typically, this is a manual and time-consuming process, as each access request is individually accessed by at least one authority entity before being approved.

Additionally, the increasing amount of data sources producing a tremendous amount of data related to people is presenting new security and privacy challenges in IoT systems. While a single data set may not affect a person's privacy, data in the single data set could theoretically be combined or related to valuable pieces of information about the person or their behavior in other data sets. As protecting data privacy is oftentimes a key objective in IoT adoption (especially when the data is shared and used by other entities), this further complicates and extends the time involved in the approval process. As security is the primary challenge in terms of implementing IoT solutions, with privacy and access control being top priorities, an improved access control system is needed.

Embodiments described herein provide techniques for implementing a Relationship-Based Access Control (RelBAC) System, where a graph database is used to store business model entities, relationships and attributes. The RelBAC System can then evaluate the graph database relations when considering a particular resource access request by a particular requestor and can determine whether the resource access request should be granted based on a defined security policy. In one embodiment, the RelBAC System can further evaluate a context associated with the resource access request. For example, the RelBAC System could determine a time at which the resource access request was received, a geographic location from which the resource access request was received, a network location from which the resource access request was received, a type and/or identity of a network connection used to submit the resource access request, and so on. More generally, the RelBAC System can take into account any suitable context attribute associated with the resource access request when determining whether to grant the requestor access to the requested resource, consistent with the functionality described herein.

A particular embodiment provides a method of managing data access within a first computing environment. The method includes receiving a request, from a first requesting entity, to access a first resource. The method further includes generating and submitting a query for a graph-based database to determine one or more relationships between the first requesting entity and other entities covered by a security policy, where the graph-based database models identities, resources and security relationships covered by the security policy. The method also includes determining, based on the determined one or more relationships and the security policy, whether the first entity is allowed to access the first resource according to the security policy.

In one embodiment, the RelBAC system is configured to generate and submit a query against the graph database pre-generate a data structure for use in processing access requests. Generally, the pre-generated data structure can facilitate look-up operations for determining whether to grant access requests, e.g., determining whether a given access request for a particular resource, from a particular requesting entity, and with an associated context should be granted. In a particular embodiment, the RelBAC system is configured to periodically

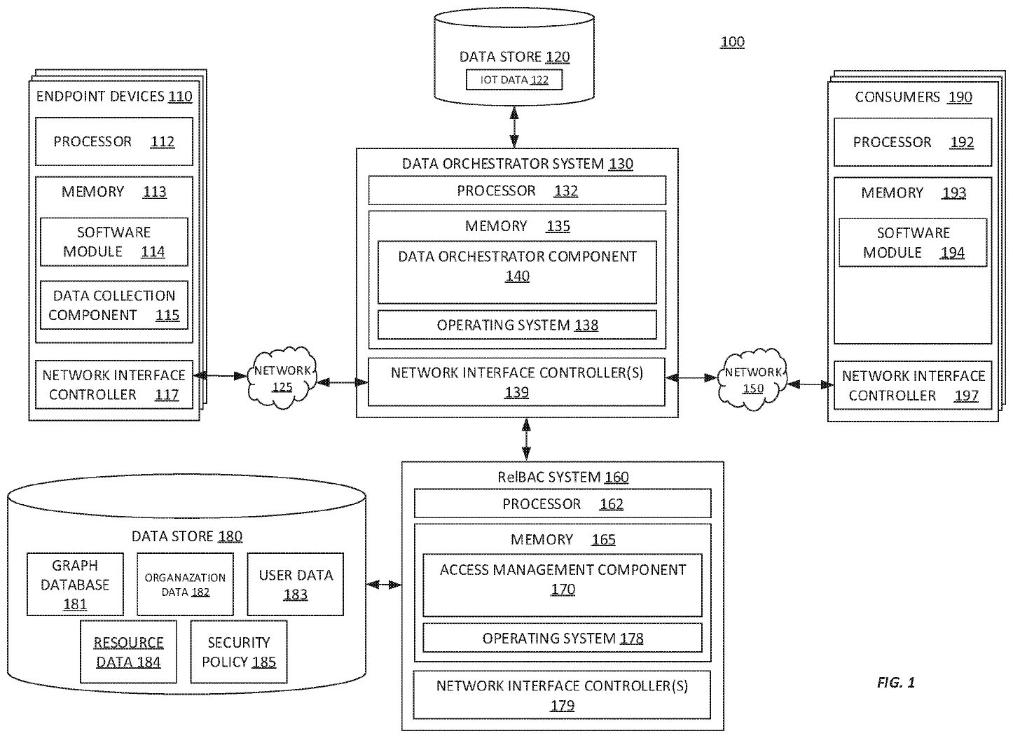

FIG. 1 illustrates a system configured with an access management component, according to one embodiment described herein. As shown, the system 100 includes Endpoint Device 110 and a Data Orchestrator System 130, interconnected via a network 125, and the Data Orchestrator System 130 and Consumers 190, interconnected via a network 150. Generally, the networks 125 and 150 represent any suitable data communications networks, with examples including (without limitation) a local area network (LAN), a wide area network (WAN), an IEEE 802.11 wireless network, and so on. Moreover, the networks 125 and 150 may be the same type of data communication network or may be different types of data communications network, relative to one another. Additionally, the system 100 includes a RelBAC System 160 connected to the Data Orchestrator System 130. For example, the RelBAC System 160 and the Data Orchestrator System 130 may be connected by a network (not shown), and such a network include any suitable data communications network, known or unknown, including those discussed above.

The Data Orchestrator System 130 includes one or more computer processors 112, a memory 113, and a network interface controller 139. The memory 113 contains a data orchestrator component 140 and an operating system 138. Generally, the data orchestrator component 140 represents software logic that can install a software module on the Consumers 190 and validate the operation of the software module. As described herein, a software module refers to any software component, including (without limitation) device firmware, a software application, a module for a software application, a suite of software applications, and so on. Generally, the operating system 138 represents any suitable operating system for a computing device. Data Orchestrator System 130 is communicatively coupled to a data store 180.

The RelBAC System 160 includes one or more computer processors 162, a memory 165 and a network interface controller 179. The memory 165 includes an access management component 170 and an operating system 178. Generally, the access management component 170 is a service that governs access to resources. For instance, the access management component 170 could receive an access request that identifies a resource using a unique resource identifier (URI) corresponding to the resource. As an example, a particular consumer 190 could request access to particular IoT data 122 within the data store 120 from the data orchestrator system 130, and before granting the access request, the data orchestrator component 140 could transmit a request to the access management component 170 in order to determine whether the consumer 190 is authorized to access the requested IoT data 122.

In a particular embodiment, the access management component 170 uses Hypertext Transfer Protocol (HTTP) for communicating with other components within the IoT network. For example, the access management component 170 could provide an Application Programming Interface (API) that complies Representational State Transfer (REST) constraints. Such an API is referred to herein as a RESTful API. In such an embodiment, an Identity Management Service (IDMS) component can receive requests and can generate responses to said requests using an HTTP-compliant format. For example, the IDMS component could generate responses formatted in the Hypertext Markup Language (HTML) format, the Extensible Markup Language (XML) format, the JavaScript Object Notation (JSON) format, and so on.

As an example, the access management component 170 could receive an access request from the data orchestrator component 140, where the access request specifies a first requesting entity that is requesting to access a first resource. For example, a first consumer 190 could have requested, from the data orchestrator component 140, to access particular IOT data 122 stored in the data store 120, where the IOT data 122 was collected by one or more of the endpoint devices 110.

Upon receiving the request from the data orchestrator component 140, the access management component 170 could generate and submit a query to be executed against the graph database 181 to determine one or more relationships between the first requesting entity and other entities covered by the security policy 184. The graph database 181 generally models identities, resources and security relationships covered by the security policy. For example, the access management component 170 could have previously generated the graph database 181 based on the organization data 182, the user data 183 and the resource data 184. In a particular embodiment, the data orchestrator component 140 is configured to execute one or more queries against the graphic database 181 and to generate, based on query results from executing the one or more queries, a lookup data structure for processing subsequently received access requests for resources. In such an embodiment, the data orchestrator component 140 can be configured to process received resource access quests using the lookup data structure and to periodically update and/or regenerate the lookup data structure by executing one or more queries against the graph database 181. Doing so may conserve computing resources, e.g., in embodiments where executing queries against the graph database 181 consumes more computing resources than processing incoming resource access requests using the lookup data structure.

Generally, the organization data 182 represents data describing relationships of entities (e.g., users, applications, resources, etc.) within a particular organization and may also specify relationships between the particular organization and other organizations. The user data 183 generally contains data describing users across one or more organizations and may include one or more unique identifiers for each of the users as well as other metadata describing the users. The resource data 184 generally contains data identifying and describing resources within the system 100. Such resources may include, for example, data within data store 120, streaming data collected by one or more of the endpoint devices 110, the endpoint devices themselves 110, the consumer 190, the software modules 194 executing on the consumers 190, and so on. More generally, it is broadly contemplated that the resource data 184 may relate to any resource within an IoT environment, consistent with the functionality described herein. In other embodiments, the graph database 181 is generated using another software application(s) (not shown), generated manually by a system administrator(s), or a combination of users and software applications.

The access management component 170 could then determine, based on the determined one or more relationships and the security policy, whether the first entity is allowed to access the first resource according to the security policy 185. Generally, the security policy 185 includes a plurality of rules that define how various actors within the IoT system can interact with the IoT platform and assets within it. For example, the security policy 185 may include, without limitation, rules that evaluate a determined identity of the first requesting entity, rules that evaluate a resource type corresponding to the first resource, rules that evaluate a connection type of the first requesting entity, rules that evaluate a time at which the request to access the first resource was received, and rules that evaluate a location of the first requesting entity, rules that evaluate any combination of the above or any other suitable attribute associated with an access request.

Additionally, the security policy 185 may contain a number of security sub-policies, including (without limitation) an individual access control sub-policy, an application and/or service access control policy, an access governance sub-policy, and so on. For instance, the individual access control sub-policy could describe how a user interacts with the IoT platform and what permissions the user has within the IoT environment. In one embodiment, the individual access control sub-policy defines a comprehensive range of actors including, without limitation, IoT platform developers (e.g., developers who build and manage software applications on the data orchestrator system 130), business developers (e.g., developers who build and manage the software modules 194 on the consumer devices 190), operations engineers (e.g., engineers who manage the underlying hardware systems of the data orchestrator system 130, endpoint devices 110 and/or consumers 190), outside contractors who perform various roles within the IoT environment, external partners of the IoT environment and other customers external to the IoT environment.

The application and/or service access control sub-policy defines how an application, service or process within the IoT environment interacts with elements of the IoT platform. For example, the application and/or service access control sub-policy could define how a particular software module 194 on a particular consumer system 190 can interact with various elements and resources within the IoT platform. The access governance sub-policy generally defines rules by which access permissions (i.e., individual or application-level permissions) are granted for sharing assets with other parties. In one embodiment, the access governance sub-policy defines how access within the IoT platform is monitored, audited and managed to ensure long-term stability and security of the IoT platform.

The Endpoint Devices each include a processor 112, memory 113, and network controller 117. The Data Orchestrator System 130 contains a processor 132, memory 135 and network interface controller(s) 139. The RelBAC System 160 contains a processor 162, a memory 165 and a network interface controller 179. The Consumers 190 each include a processor 192, memory 193 and a network interface controller 197. Any general-purpose computer systems used in various embodiments of this disclosure may be, for example, general-purpose computers with general-purpose computer processors. For example, the processors 112, 132, 162 and 192 may include processors based on Intel PENTIUM-type processor, Motorola PowerPC, Sun UltraSPARC, Hewlett-Packard PA-RISC processors, ARM-based processors or any other type of processor. Generally, the processors 112, 132, 162 and 192 represent any suitable processor(s), including commercially available processors such as the well-known Pentium class processor available from the Intel Corporation. Many other processors are available. Such a processor usually executes an operating system (e.g., the processor 132 can execute the operating system 138, the processor 162 can execute the operating system 178, etc.) which may be, for example and without limitation, Microsoft® Windows®, Apple® macOS®, Solaris®, UNIX®, or Linux®. Many other operating systems may be used.

The memories 113, 135, 165 and 193 generally represents any suitable form of addressable computer memory. For example, the memories 113, 135, 165 and 193 may represent a volatile memory (e.g., static random-access memory (SRAM)) and/or a non-volatile memory (e.g., Flash memory). More generally, any suitable form of memory device(s) can be used, consistent with the functionality described herein. Generally, the processor and operating system together define a computer platform for which application programs in high-level programming languages are written. It should be understood that embodiments of the present disclosure are not limited to a particular computer system platform, processor, operating system, or network. Also, it should be apparent to those skilled in the art that the present disclosure is not limited to a specific programming language or computer system. Further, it should be appreciated that other appropriate programming languages and other appropriate computer systems could also be used.

In the depicted embodiment, the memories 113 and 193 contain software modules 114 and 194, respectively. Additionally, the memory 113 contains a data collection component 115 that is generally configured to collect data for a data metric(s) on the endpoint devices 110. For example, in a power management context, the data collection component 115 could collect power metric data from one or more sensor devices of the endpoint devices 110. Generally, the software modules 114 and 194 represent application-specific software for the IoT environment. For example, in a power management context, the software modules 114 on the endpoint devices 110 could include power monitoring logic, while the software modules 194 could include power metric processing logic and monitoring and analytics services.

The Endpoint Devices 110, Data Orchestrator System 130, RelBAC System 160 and Consumers 190 may use the network interface controllers 117, 139, 179 and 197, respectively, to send and receive data on one or more data communication networks (e.g., networks 125 and 150). One or more portions of the computer system may be distributed across one or more computer systems coupled to a communications network. For example, as discussed above, a computer system that determines available power capacity may be located remotely from a system manager. These computer systems also may be general-purpose computer systems. For example, various aspects of the disclosure may be distributed among one or more computer systems configured to provide a service (e.g., servers) to one or more client computers, or to perform an overall task as part of a distributed system. For example, various aspects of the disclosure may be performed on a client-server or multi-tier system that includes components distributed among one or more server systems that perform various functions according to various embodiments of the disclosure. These components may be executable, intermediate (e.g., IL) or interpreted (e.g., Java) code which communicate over a communication network (e.g., the Internet) using a communication protocol (e.g., TCP/IP). For example, one or more database servers may be used to store device data, such as expected power draw, that is used in designing layouts associated with embodiments of the present disclosure.

As shown, the memory 135 also contains an operating system 138. Similarly, the memory 165 contains an operating system 178. Generally, the operating systems 138 and 178 manage at least a portion of the hardware elements included in Data Orchestrator System 130 and the RelBAC System 160, respectively. Usually, a processor or controller, such as processors 132 and 162, executes an operating system which may be, for example, a Windows-based operating system, such as, Windows 10, Windows NT, Windows 2000 (Windows ME), Windows XP or Windows Vista operating systems, available from the Microsoft Corporation, a MAC OS System X operating system available from Apple Computer, one of many Linux-based operating system distributions, for example, the Enterprise Linux operating system available from Red Hat Inc., a Solaris operating system available from Sun Microsystems, or a UNIX operating system available from various sources. Many other operating systems may be used, and embodiments are not limited to any particular implementation.

The data orchestrator component 140 is generally configured to route data between the endpoint devices 110 and the consumers 190 in a secure manner. In a particular embodiment, the data orchestrator component 140 is configured to route such data while avoiding the limitations of conventional tenancy models. In one embodiment, the data orchestrator component 140 receives, from an endpoint device 110, a plurality of data values collected by the endpoint device 110. The data orchestrator component 140 can determine an identifier that uniquely identifies the endpoint device. The data orchestrator component 140 could dynamically generate one or more routing tables 182 based on at least one of (i) device claim information relating to the endpoint device, (ii) license data relating to the one or more data consumers, and (iii) user information associated with the one or more data consumers. The data orchestrator component 140 could then access the generated routing tables using the determined identifier and device type data corresponding to the plurality of data values to determine one or more data consumers to route the plurality of data values to. The data orchestrator component 140 could then transmit at least a portion of the plurality of data values to the determined one or more data consumers.

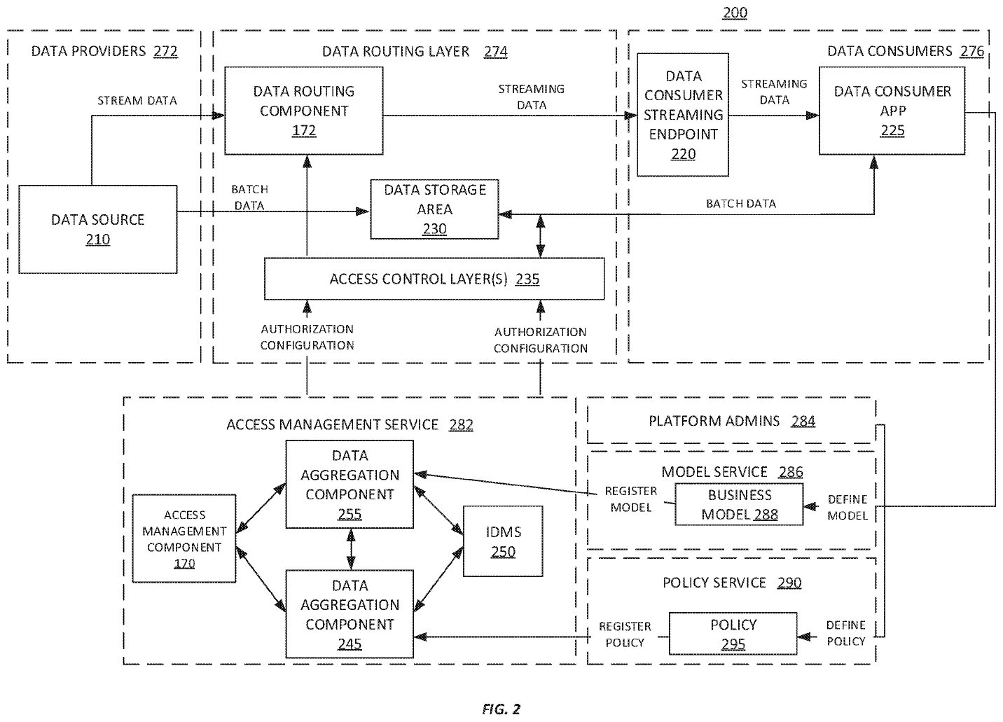

FIG. 2 is a block diagram illustrating a system configured with an access management component and a data flow within the system, according to one embodiment described herein. As shown, the system 200 includes data providers layer 272, a data routing layer 274, a data consumers layer 276, a platform admins layer 284, an access management service 282 and a model service 286 and a policy service 290. Within the data providers layer 272, a data source 210 procures ownership credentials from a register data provider 240 within the claim service layer 280. For example, the data source 210 could be an endpoint device 110, and the data source 210 could procure the ownership credentials from the register data provider 240 as part of a device registration process.

In the depicted embodiment, the data source 210 streams data to the data routing component 172 within the data routing layer 274. Generally, the access control layer(s) 235 can consume the access control data from the access management service 282, and can generate and provide routing information to the data routing component 172. The data routing component 172 can combine such data routing information and access control data with actual access context information (e.g., one or more assess claim tokens presented by the data consumer application 225 on behalf of a user) to determine whether and how to route each piece of data. This enables the data routing layer 274 to correctly deliver a customized data view to the application and user for consumption, while ensuring security and data privacy requirements are met.

Moreover, the data routing layer 274 can do so for both batch data and streaming data. Generally, the data routing layer 274 can selectively provide data from the data providers 272 to the data consumers 276 in a number of different ways, including a pub/sub methodology (e.g., where the data consumer application 225 subscribes to one or more types of data, and the data routing layer 274 publishes data received from the data providers 272 to authorized subscribers), a push methodology (e.g., where the data routing layer 274 selectively transmits data received from the data providers 272 to one or more data consumers 276), a pull methodology (e.g., where the data routing layer 274 stores data received from the data providers 272 in the data storage area 230, and the stored data can be provided to data consumers 276 the access control layer(s) 235 determines have sufficient authorization to access the data upon request), and so on. For example, in the case of streaming data, the data routing layer 274 could employ a pub/sub methodology or a push methodology to transmit the data to the data consumers 276. As another example, in the case of batch data, the data routing layer 274 could store the data in the data storage area 230 and authorized data consumers 276 can pull the data from the data storage area 230 upon authorization by the access control layer(s) 235.

The data routing component 172 also receives authorization and data routing information from the access management service 282, via the access control layer(s) 235. Such authorization information can include real-time data from the IDMS, and can include identifying a user(s) associated with the data source 210 (e.g., a user setup as an owner of the data source device), a role(s) of the user, device claim information relating to the user and/or the data source 210, and so on. Additionally, the authorization and routing configuration data can include license data Generally, the routing configuration information received from the access management service 282 can include one or more routing tables that specify how to route data of various types and from various sources.

Additionally, the data source transmits batch data to a data storage area component 230 within the data routing layer 274. An access control layer(s) 235 within the data routing layer 274 receives authorization configuration data from the access management service 282, and using these data selectively transmits the batch data (or a portion of the filtered batch data) to the data consumer app 225 within the data consumers layer 276. The streaming and batch data received by the data consumer application 225 can then be processed and used in an application-specific manner. For example, in a power management context, the data could be processed to generate various analytics, used by monitoring services, used to generate a visualization of the state of the data source 210, or more generally for any other suitable purpose.

The access management service 282 includes the access management component 170, as well as data aggregation components 245 and 255 and the IDMS 250. Generally, the data aggregation components 245 and 255 are configured to collect data from various sources and to aggregate and normalize these data for consumption by the access management component 170. For example, the data aggregation component 245 in the depicted example collects data on registered policies from the policy service 290. In the depicted embodiment, the platform admins 284 work to define the policy 295 at the policy service 290, and the policy service 290 then registers the defined policy with the data aggregation component 245. As discussed above, the policy 295 generally defines rules to be enforced to ensure the security of the IoT system. In one embodiment, the policy service 290 is configured to register a number of sub-policies with the data aggregation component 245, including an individual access control sub-policy, an application or service access control sub-policy and an access governance sub-policy. The data aggregation component 245 could then aggregate the policy data and provide the policy data to the access management component 170 for use in generating the authorization and routing configurations.

Additionally, the data aggregation component 255, as depicted, provides an API through which the model service 286 can register a business model data structure 288. In the depicted embodiment, the data consumer application 225 defines the business model 288, e.g., via an API provided by the model service 286. Generally, such a business model 288 defines various entities within an IoT computing network, such as devices, data stores, applications and services, and so on. Additionally, the business model 288 can define relationships between the various entities.

Generally, the access management service 282 can consume various access claims and rights data (e.g., from a claim service, a licensing service, the RelBAC System 160, etc.) and can generate access control configurations and/or structures consumed by the data routing layer 274. For example, the access management component 170 can dynamically generate one or more routing tables based on the authorization and routing configuration information, and these routing tables can be provided to the data routing component 172, which can use the routing table to selectively route the streaming data to a data consumer streaming endpoint 220. Doing so enriches existing access control data, and may further allow access control data to be constructed from scratch, in a manner reflective of both the data provider access rights (e.g., devices emitting telemetry streams) and data consumer access rights (e.g., advisor applications), as well of enterprise access control relationships and grants, such as what may be supplied by enterprise access-control system. Generally, the access control service has enough information to provide customized, least-privilege view of data for a given use context (e.g., a user viewing historical data, dashboard data, analytics report, etc.), while also respecting the user's relationship to the broader data ownership, lineage, and governance contexts, such as when the user is acting on behalf of an enterprise which is the actual owner of the data provider devices.

Additionally, the access management service 282 can receive data from a number of other sources and can use this information when dynamically generating the routing tables. In the depicted embodiment, the access management service 282 receives information from other authentication/authorization providers 270, which may include Role-based Access Control (RBAC) services, Relationship-based Access Control (RelBAC) services, and so on. More generally, any other information that is suitable for use in access control determinations can be used, consistent with the functionality described herein.

For example, the access management component 170 could receive aggregated business model data structures from the data aggregation component 255 as well as aggregated security policy data structures from the data aggregation component 245. The access management component 170 could generate a graph database based on the aggregated business model data, where the graph database models identities, resources and security relationships covered by the aggregated security policy data. Generally, a graph database refers to a particular type of database that, unlike conventional relational databases, uses graph structures having nodes, edges and properties to store data, and generally is configured to execute semantic queries against the stored graph structures.

Upon receiving an access request from a requesting entity (e.g., a data consumer application 225) for a particular resource within the IoT environment (e.g., data in data storage area 230), the access management component 170 can generate a semantic query to be executed against the graph database and configured to determine relationships between the requesting entity and other entities within the IoT environment. The access management component 170 could then execute the generated semantic query against the graph database to determine the requesting entities' relationships with other entities within the IoT environment. Additionally, the access management component 170 could retrieve one or more security policies (e.g., from the data aggregation component 245) corresponding to the requested resource, where the one or more security policies include one or more rules that define access requirements for the requested resource. The access management component 170 could then evaluate the determined relationships associated with the requesting entity to determine whether the relationships satisfy the security policy's rules associated with the requested resource. If the access management component 170 determines the relationships sufficiently satisfy the rules of the security policy, the access management component 170 can grant the request; if the access management component 170 determines the rules are not satisfied, the access management component 170 could deny the request.

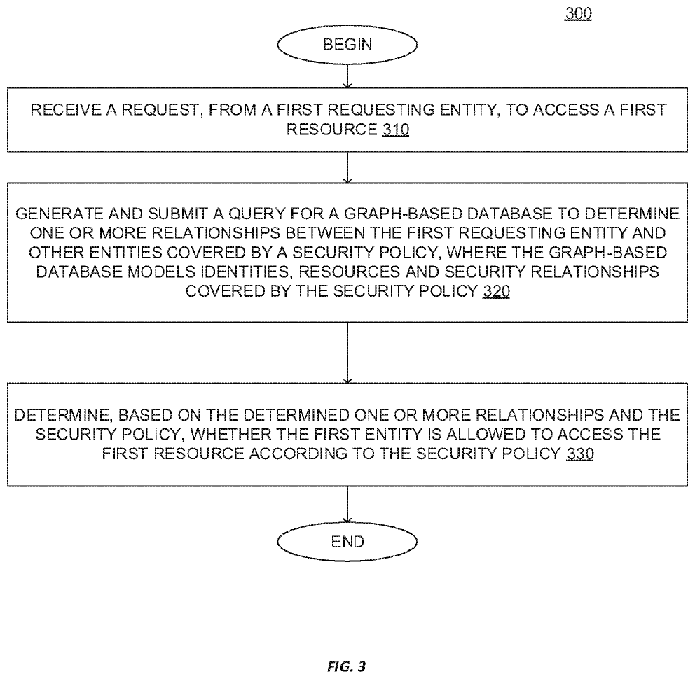

FIG. 3 is a flow diagram, illustrating a method of managing data access within a first computing environment. As shown, the method 300 begins at block 310, where the access management component 170 receives a request, from a first requesting entity, to access a first resource. The access management component 170 generates and submits a query for a graph-based database to determine one or more relationships between the first requesting entity and other entities covered by a security policy, where the graph-based database models identities, resources and security relationships covered by the security policy (block 320). The access management component 170 then determines, based on the determined one or more relationships and the security policy, whether the first entity is allowed to access the first resource according to the security policy (block 330), and the method 300 ends.

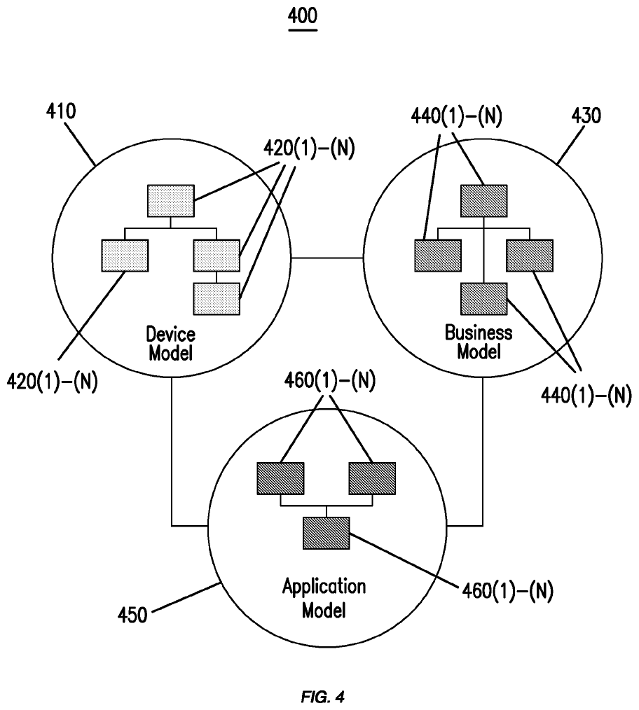

FIG. 4 is a diagram illustrating an organization of a graph database that models identities, resources and security relationships, according to one embodiment described herein. As shown, the graph database 400 includes a device data model 410 which includes a plurality of devices 410(1)-(N) and defines relationships between the devices, a business data model 430 that includes a plurality of business entities 440(1)-(N) and defines relationships between the business entities, and an application data model 450 that includes a plurality of application entities 460(1)-(N) and defines relationships between the application entities. Moreover, at a higher level, the graph database 400 defines relationships between the device data model 410, the business data model 430 and the application data model 450. In one embodiment, the access management component 170 is configured to generate the graph database 400 based on aggregated business model data, user data from an identity management services (e.g., IDMS 250 shown in FIG. 2), and other data defining attributes of the IoT environment. In a particular embodiment, the graph database 400 is generated through other means (e.g., via another service or software application, via a system administrator, etc.) and is provided to the access management component 170 for use in accessing access requests in view of one or more security policies. Of course, the graph database 400 is provided for illustrative purposes only and more generally, the access management component 170 can be configured to generate and execute queries against any graph database having a suitable organization and schema, consistent with the functionality described herein.

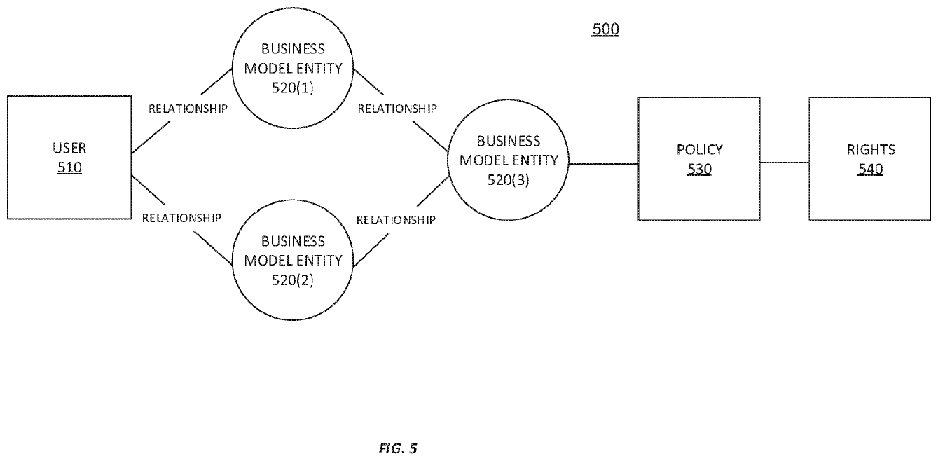

FIG. 5 is a block diagram illustrating elements of a RelBAC system, according to one embodiment described herein. As an example, assume that the diagram 500 depicts a user 510 who has submitted a resource access request that is being accessed by the access management component 170. As shown, the access management component 170 has generated and executed a semantic query against a graph database and has determined that the user 510 is related to business model entities 520(1) and 520(2). For example, the user could be employed by a particular business represented by business model entity 520(1) and could be a member of a specific project team within the business, as represented by the business model entity 520(2). Additionally, the access management component 170 has determined that the business model entities 520(1) and 520(2) are related to another business model entity 520(3). For example, the business model entity 520(3) could represent a different business that is partnering with the user's business for purposes of a particular project. The access management component 170 can then assess the determined relationships for the user 510, along with the resource for which access is being requested, against rules defined in the security policy 530. In the depicted embodiment, the access management component 170 has determined that the user's relationships satisfy the rules of the security policy 530 and accordingly has granted the user access rights 540 to the requested resource.

As discussed above, embodiments provide an access control system that is dynamic, flexible, highly scalable and open. The access control system described herein can secure the control plane for IoT devices as well as protecting the data collected by the IoT devices, by utilizing graph technology to provide more fine-grained access control. By doing so, embodiments offer a technological improvement to conventional systems which rely on relational databases to perform role-based and attribute-based access control, as embodiments described herein offer flexibility and performance advantages over these conventional solutions while ensuring security is maintained within the IoT environment.

In the preceding, reference is made to various embodiments. However, the scope of the present disclosure is not limited to the specific described embodiments. Instead, any combination of the described features and elements, whether related to different embodiments or not, is contemplated to implement and practice contemplated embodiments. Furthermore, although embodiments may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

The various embodiments disclosed herein may be implemented as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer-readable medium(s) having computer-readable program code embodied thereon.

Any combination of one or more computer-readable medium(s) may be utilized. The computer-readable medium may be a non-transitory computer-readable medium. A non-transitory computer-readable medium may be, for example, but not limited to, an electronic, magnetic, optical, electromagnetic, infrared, or semiconductor system, apparatus, or device, or any suitable combination of the foregoing. More specific examples (a non-exhaustive list) of the non-transitory computer-readable medium can include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages. Moreover, such computer program code can execute using a single computer system or by multiple computer systems communicating with one another (e.g., using a local area network (LAN), wide area network (WAN), the Internet, etc.). While various features in the preceding are described with reference to flowchart illustrations and/or block diagrams, a person of ordinary skill in the art will understand that each block of the flowchart illustrations and/or block diagrams, as well as combinations of blocks in the flowchart illustrations and/or block diagrams, can be implemented by computer logic (e.g., computer program instructions, hardware logic, a combination of the two, etc.). Generally, computer program instructions may be provided to a processor(s) of a general-purpose computer, special-purpose computer, or other programmable data processing apparatus. Moreover, the execution of such computer program instructions using the processor(s) produces a machine that can carry out a function(s) or act(s) specified in the flowchart and/or block diagram block or blocks.

The flowchart and block diagrams in the Figures illustrate the architecture, functionality and/or operation of possible implementations of various embodiments of the present disclosure. In this regard, each block in the flowchart or block diagrams may represent a module, segment or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It is to be understood that the above description is intended to be illustrative, and not restrictive. Many other implementation examples are apparent upon reading and understanding the above description. Although the disclosure describes specific examples, it is recognized that the systems and methods of the disclosure are not limited to the examples described herein but may be practiced with modifications within the scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

We claim:

1. A method of managing data access within a first computing environment, comprising:
receiving a request, from a first requesting entity, to access a first resource;
generating and submitting a query for a graph-based database to determine one or more relationships between the first requesting entity and other entities covered by a security policy, wherein the graph-based database models identities, resources and security relationships covered by the security policy; and
determining, based on the determined one or more relationships and the security policy, whether the first entity is allowed to access the first resource according to the security policy.

2. The method of claim 1, wherein the first requesting entity comprises a first application, and wherein the first resource comprises data collected by an Internet of Things (IoT) device.

3. The method of claim 1, wherein determining whether the first entity is allowed to access the first resource according to the security policy further comprises determining whether the determined one or more relationships satisfy one or more predefined conditions defined by the security policy.

4. The method of claim 1, wherein determining whether the first entity is allowed to access the first resource according to the security policy is based on a determined identity of the first requesting entity, a resource type corresponding to the first resource, a connection type of the first requesting entity, a time at which the request to access the first resource was received, and a location of the first requesting entity.

5. The method of claim 1, wherein the security policy comprises an individual access control policy that defines how individuals can interact with elements within the first computing environment and one or more permissions associated with the individuals.

6. The method of claim 5, wherein the security policy further comprises an application/service access control policy that defines how an application, service or process interacts with the elements within the first computing environment.

7. The method of claim 6, wherein the security policy further comprises an access governance policy that defines rules by which access permissions are granted for sharing resources with other parties, how access is monitored, audited and managed.

8. The method of claim 1, wherein the security policy comprises a plurality of rules, wherein each rule defines a principal and one or more relationships that determine whether the principal is allowed to access a specified resource.

9. A non-transitory computer-readable medium containing computer program code that, when executed by operation of one or more computer processors, performs an operation for managing data access within a first computing environment, the operation comprising:
receiving a request, from a first requesting entity, to access a first resource;
generating and submitting a query for a first database to determine one or more relationships between the first requesting entity and other entities covered by a security policy, wherein the first database models identities, resources and security relationships covered by the security policy;
determining a context associated with the received request; and
determining, based on the determined one or more relationships, the security policy and the determined context, whether the first entity is allowed to access the first resource according to the security policy.

10. The non-transitory computer-readable medium of claim 9, wherein the first requesting entity comprises a first application, and wherein the first resource comprises data collected by an Internet of Things (IoT) device.

11. The non-transitory computer-readable medium of claim 9, wherein determining whether the first entity is allowed to access the first resource according to the security policy further comprises determining whether the determined one or more relationships satisfy one or more predefined conditions defined by the security policy.

12. The non-transitory computer-readable medium of claim 9, wherein determining the context associated with the received request further comprises:
determining an identity of the first requesting entity;
determining a resource type corresponding to the first resource;
determining a connection type of the first requesting entity;
determining a time at which the request to access the first resource was received; and
determining a location of the first requesting entity.

13. The non-transitory computer-readable medium of claim 9, wherein the security policy comprises an individual access control policy that defines how individuals can interact with elements within the first computing environment and one or more permissions associated with the individuals.

14. The non-transitory computer-readable medium of claim 13, wherein the security policy further comprises an application/service access control policy that defines how an application, service or process interacts with the elements within the first computing environment.

15. The non-transitory computer-readable medium of claim 14, wherein the security policy further comprises an access governance policy that defines rules by which access permissions are granted for sharing resources with other parties, how access is monitored, audited and managed.

16. The non-transitory computer-readable medium of claim 1, wherein the security policy comprises a plurality of rules, wherein each rule defines a principal and one or more relationships that determine whether the principal is allowed to access a specified resource.

17. A system, comprising:
one or more computer processors; and
a non-transitory computer-readable memory containing computer program code that, when executed by operation of the one or more computer processors, performs an operation for managing data access within a first computing environment, the operation comprising:
submitting one or more queries to be executed against a graph database, wherein the graph-based database models identities, resources and security relationships covered by the security policy;
compiling a lookup data structure based on a set of query results produced by the execution of the one or more queries against the graph database;
receiving a request, from a first requesting entity, to access a first resource;
determining one or more relationships between the first requesting entity and other entities covered by a security policy using the lookup data structure; and
determining, based on the determined one or more relationships and the security policy, whether the first entity is allowed to access the first resource according to the security policy.

18. The system of claim 17, wherein the first requesting entity comprises a first application, wherein the first resource comprises data collected by an Internet of Things (IoT) device, wherein determining whether the first entity is allowed to access the first resource according to the security policy further comprises determining whether the determined one or more relationships satisfy one or more predefined conditions defined by the security policy.

19. The system of claim 18, wherein determining whether the first entity is allowed to access the first resource according to the security policy is further based on a determined identity of the first requesting entity, a resource type corresponding to the first resource, a connection type of the first requesting entity, a time at which the request to access the first resource was received, and a location of the first requesting entity.

20. The system of claim 17, wherein the security policy comprises an individual access control policy that defines how individuals can interact with elements within the first computing environment and one or more permissions associated with the individuals, wherein the security policy further comprises an application/service access control policy that defines how an application, service or process interacts with the elements within the first computing environment, wherein the security policy further comprises an access governance policy that defines rules by which access permissions are granted for sharing resources with other parties, how access is monitored, audited and managed.
